(19) United States
(12) Patent Application Publication
(10) Pub. No.: US 2023/0187737 A1
(43) Pub. Date: Jun. 15, 2023

(54) HOUSING COMPONENT FOR A PRISMATIC CELL HOUSING, CELL HOUSING, AND METHOD FOR PRODUCING A HOUSING COMPONENT

(71) Applicant: AUDI AG, Ingolstadt (DE)

(72) Inventor: Tamas GYULAI, Pfaffenhofen an der llm (DE)

(73) Assignee: AUDI AG, Ingolstadt (DE)

(21) Appl. No.: 18/075,767

(22) Filed: Dec. 6, 2022

(30) Foreign Application Priority Data
Dec. 9, 2021 (DE) 102021132477.7

(51) Int. Cl. H01M 50/103; H01M 50/15; H01M 50/169

(52) U.S. Cl. CPC H01M 50/103; H01M 50/15; H01M 50/169

(57) ABSTRACT

A housing component for a prismatic cell housing of a battery cell, which includes a base body formed as a hollow profile and two covers that are welded or are to be welded to opposite sides of the base body with respect to a first direction. The housing component is provided as a first housing component to be welded to at least one second housing component of the cell housing, and the first housing component represents the base body or one of the two covers. The first housing component includes an edge area to be arranged on the second housing component. The edge area has a cross-sectional geometry that varies in the first direction with respect to a cross section through the edge area that is parallel to the first direction.

### FIELD

The invention relates to a housing component for a prismatic cell housing of a battery cell, which comprises a base body formed as a hollow profile and two covers which are welded or are to be welded to opposite sides of the base body with respect to a first direction, wherein the housing component is provided as a first housing component to be welded to at least one second housing component of the cell housing, and wherein the first housing component represents the base body or one of the two covers. Furthermore, the invention also relates to a cell housing and a method for producing at least part of a prismatic cell housing.

### BACKGROUND

In the case of the prismatic battery cells that have been typical up to this point, in particular for high-voltage batteries in motor vehicles, the cell poles or cell terminals and a vent element, which provides a releasable degassing opening, are arranged on the upper side of the cell, i.e., at the highest point of the cell when the cell is installed as intended in the motor vehicle. However, geometries and formations of prismatic cells differing therefrom are currently increasingly coming into focus.

For example, DE 10 2018 207 327 A1 describes a storage device for storing electrical energy for a motor vehicle having a plurality of storage cells arranged in succession along a stacking direction and forming at least one cell stack. In this case, each of the storage cells comprises at least two connection elements which are arranged laterally, in particular on sides of the storage cell facing away from one another. Furthermore, the storage cell has a bursting membrane which is arranged on the upper side. The cell housing can have exactly three housing parts which are each formed integrally and separately from one another and are connected to one another, or exactly two housing parts which are each formed integrally and separately from one another and are connected to one another and are formed as shell elements. For example, the upper wall and the lower wall can be formed integrally with one another and/or integrally with the front wall and the rear wall. Two side walls, which function as covers, can be connected by material bonding, in particular welded, to the upper wall, the lower wall, the front wall, and the rear wall.

Due to the novel cell geometry, in particular with regard to the arrangement of the cell poles, the manufacturing process for producing such cell housings is also influenced or changed. Ideally, such cell housings are to be able to be manufactured as simply and cost-effectively as possible. At the same time, these housings also have to meet high safety requirements and, for example, it has to be ensured that the joints at which the individual housing components are joined to one another are also designed to be robust enough to last the service life of the cell. Another aspect that always has to be taken into consideration during manufacturing is certain component tolerances. These make it difficult to adapt the individual components to one another, as well as the joining process.

### SUMMARY

It is therefore the object of the present invention to provide a housing component for a prismatic cell housing, a cell housing, and a method which make it possible to provide a cell housing in the simplest and most cost-effective manner possible and at the same time in a safe and robust manner.

A housing component according to the invention for a prismatic cell housing of a battery cell, which comprises a base body formed as a hollow profile and two covers which are welded or are to be welded to opposite sides of the base body with respect to a first direction, is provided as a first housing component to be welded to at least one second housing component of the cell housing, wherein the first housing component provides the base body or one of the two covers. The first housing component has an edge area to be arranged on the second housing component, wherein the edge area has a cross-sectional geometry that varies in the first direction in relation to a cross section through the edge area that is parallel to the first direction.

By way of such an edge area, which has a varying cross-sectional geometry, both the manufacturing method for manufacturing the cell housing can be made simpler and the joining of the individual housing components to one another can be made more reliable and robust. This applies both to the case when the housing component is designed as the above-mentioned base body formed as a hollow profile and when the housing component is formed as one of the two covers. Due to the varying cross-sectional geometry, a tolerance compensation may be provided, for example, using which component tolerances between the base body and the cover may be absorbed. In addition, it is possible to deliberately provide an optimized area for a later weld seam placement, in particular in the form of a weld joint, in the arrangement area between the base body and the cover by providing a corresponding recess, either in the base body and/or in the cover. Ultimately, this results in a significantly more robust and stable welded bond between the components to be joined. If the housing component is provided, for example, as the base body formed as a hollow profile, it can simply be provided at its open ends with such a peripheral edge geometry, for example by suitable processing steps, for example milling or the like, before joining with the corresponding covers to be attached at these open ends. In addition, the base body, which is formed as a hollow profile, can thus be easily provided as an integral, extruded hollow profile. In particular, this enables the base body to be provided in a simple manner in large piece counts, since these base bodies can be provided easily by fragmenting, i.e., by cutting into pieces, an extruded long strand. The varying cross-sectional geometry in the edge area may then be easily provided by a separate processing step on one or preferably both ends of the base body. If, on the other hand, the housing component is designed as such a cover, it can also be provided with a corresponding peripheral edge geometry, in particular also by suitable processing methods. In this way, an extremely robustly assembled cell housing may ultimately be provided in a particularly simple and cost-effective manner. The varying cross-sectional geometry enables both an extremely robust weld seam placement and the compensation of component tolerances, which in turn simplifies the manufacturing as such.

The cell housing of the battery cell, for which the housing component according to the invention and its embodiments explained in more detail below is to be provided, and which itself is also to be regarded as included in the invention, thus comprises, as described, a base body formed as a hollow profile and two covers. The base body and the two covers are preferably made of metallic material, particularly preferably aluminum. Furthermore, it is preferred, as will be explained in more detail hereinafter, that the two cell poles for the battery cell, in particular the pole taps, also called cell terminals, are arranged on the covers, in particular exactly one such cell terminal per cover. These terminals are also made of a metallic material. The releasable degassing opening mentioned at the outset, in particular the vent element, is preferably not arranged on one of the covers, but instead on the base body. To provide the cell housing, the two covers are welded to the respective opposite, open ends of the base body. Without the cover arranged on the base body, the base body, due to its design as a hollow profile, correspondingly has a through-opening which extends in the above-mentioned first direction. For simplified description of further features of the base body and the cover, a center axis of the base body can also be defined in such a way that it extends in parallel to the first direction and runs centrally through the base body, i.e., in the center with respect to a second and third direction, which are perpendicular to one another and to the first direction. The housing wall provided by the base body thus encloses this central center axis in the radial direction. In this case, the radial direction means, in particular, any direction pointing away from the central center axis and perpendicular to the central center axis. Viewed in cross section perpendicularly to this center axis, the housing wall provided by the base body has an essentially rectangular geometry. Essentially means here that the base body can be formed having rounded corners or rounded edges running in the first direction, both on the inside and on the outside.

In general, the first direction is defined with respect to the base body such that these open ends are opposite to one another with respect to the first direction. With respect to the cover, the first direction is defined as if it were arranged as intended on the base body. The cover surface facing toward the interior of the cell housing and the cover surface facing toward the environment are then correspondingly oriented perpendicularly to the first direction or the corresponding surface normals of these cover surfaces are aligned in parallel to the first direction. If the housing component represents the base body, then the edge area is defined as comprising the end of the base body with respect to the first direction. In this case, the base body has two edge areas that delimit its extension in the first direction. Both such edge areas can be formed having a correspondingly varying cross-sectional geometry. For simplification, the cross-sectional geometry explained above and the cross-sectional geometry described in more detail hereinafter are only explained with respect to a single such edge area, but if the housing component is formed as a base body, they can also apply analogously to the other edge area of the base body that is opposite with respect to the first direction. The edge area with respect to one of the covers is defined as delimiting the cover perpendicularly to the first direction, in particular closed circumferentially around a center axis of the cover parallel to the first direction, i.e., delimiting in every direction perpendicular to the first direction. It is also preferred in this case that both covers of the cell housing can be formed identically, i.e., both covers can have a varying cross-sectional geometry in the edge area, although this is only explained with reference to one cover for simplification. If the cell housing is assembled from the individual housing components mentioned, the joining direction in which the components are assembled corresponds to the first direction. In other words, respective covers can be placed on one of the open ends of the base body by moving in the direction of the base body in or counter to the first direction and then welded on. Due to the machined surfaces on both ends of the body and/or due to the machined surfaces in the edge area of the cover, tolerance compensation can advantageously be provided during joining and a particularly robust weld seam can be placed.

The cover is preferably not simply laid or placed frontally on the hollow body of the base body, but rather the cover has, in the radial direction measured relative to the center axis defined above, at least in some areas a smaller outer diameter than the inner diameter of the hollow body, which is provided by the base body. The term “in some areas” here refers to the first direction and not to the circumferential direction. As a result, the cover can partially protrude into the interior of the base body. The cover thus closes the hollow body in the same way that a cork closes a bottle. This enables an extremely stable connection between the cover and the base body. Again, this applies in particular to both covers.

The cross-sectional geometry relates to a cross section through the edge area parallel to the first direction and, for example, parallel to the center axis defined above. The cross-sectional plane is preferably perpendicular to the cell housing wall of the observed housing component, i.e., either the cover or the base body.

According to one preferred embodiment of the invention, the first housing component represents the base body formed as a hollow profile, which has a length in the first direction, a width in a second direction perpendicular to the first direction, and a height in a third direction perpendicular to the first and second directions.

In principle, the design of the cell housing having a base body formed as a hollow profile and two corresponding covers has proven to be particularly advantageous and more efficient, since these housing components may be manufactured particularly easily and cost-effectively, as already mentioned above. In particular, the base body formed as a hollow profile can be manufactured in a simple and cost-effective manner as an extruded component, which makes it possible, for example, to extrude numerous such base bodies in the form of a strand and then cut them to length in order to provide numerous such base bodies. Subsequently, these hollow profiles can be processed in the edge area to provide the varying cross-sectional geometry.

Furthermore, it is preferred that the edge area comprises an edge that delimits the base body in the first direction and provides an end face of the base body, wherein the edge area is formed in such a way that an inner diameter of the base body, which defines an inner dimension of the base body in the second and/or the third direction, decreases in the edge area with increasing distance from the edge. The inner diameter of the base body formed as a hollow profile thus decreases with increasing distance from the edge. However, this only applies to the edge area of the base body. In other areas of the base body, for example the remaining area of the base body later referred to as the central area of the base body, this can be formed having a consistently thick wall thickness. The above-described advantages can be achieved precisely through this tapering geometry in the edge area. For example, if a cover has a height and width in the second and third direction that is slightly subject to tolerances, this cover can simply be placed on the end of the hollow body in or counter to the first direction and moved towards the hollow body and partially into it until the cover ultimately comes into contact with its outside edge area on the inside edge area of the base body. The tapering inner geometry of the base body ensures that the cover comes into contact. Slipping through into the interior of the hollow body can thus be avoided. In addition, this means that the cover does not have to protrude beyond the base body in the radial direction, in particular, the end face providing the edge of the base body with respect to the first direction can be kept free in order to provide the welded bond here. The tapering geometry of the base body moreover supports the cover with respect to the first direction. This also stabilizes the weld seam when it has been placed between the cover and the base body in this frontal area of the base body.

The tapering of the inner diameter of the base body can be provided in a simple manner, for example, by a beveled inner edge in the edge area. It is particularly advantageous if the tapering is not linear with increasing distance from the edge, but rather non-linear and, for example, different in different sections that differ with respect to their distance from the edge. As a result, the at least two primary functions of this tapering inner geometry, namely the provision of tolerance compensation and the provision of a weld joint or depression for placing the weld seam, can be implemented in a significantly more efficient and improved manner.

It therefore represents a further very advantageous embodiment of the invention if the edge area has a first section with respect to the first direction, wherein the first section encompasses the edge, and wherein the first section has a beveled edge facing toward the interior, in particular an edge beveled according to a first angle of inclination in relation to the first direction. Such a beveled edge allows a wedge-shaped depression to be provided frontally, in particular on the boundary surface or arrangement surface for the second housing component, in particular one of the covers. If the cover and the base body are connected to one another by a weld seam in this area, welding filler materials in a molten state can be accommodated by this depression or joint. As a result, a significantly more robust weld seam can be provided and the lateral flowing out of the welding filler materials can be prevented or reduced. A weld joint, so to speak, can be provided by this geometric cross-sectional tapering in the edge area.

In a further advantageous embodiment of the invention, the edge area has a second section with respect to the first direction, which adjoins the first section, wherein the second section comprises an inner side facing toward the interior, which is inclined with respect to the first direction, in particular via a second angle of inclination that is less than the first angle of inclination and is in the single-digit degree range. For example, this angle of inclination can be inclined by one to two degrees relative to the first direction or by a maximum of one degree or two degrees. This inclination range is used, so to speak, for the tolerance compensation described above. A cover therefore advantageously does not have to be exactly matched in its extension in the second and third direction to a specific inner diameter of the hollow body in order to be at least partially accommodated in the hollow body, at least in the edge area. Tolerance compensation can thus advantageously be provided by the slight tapering of the inner diameter in this second section of the base body. At the same time, this makes it possible to provide a supporting effect in relation to the first direction in the direction of the base body center, as has already been described above. Since the resulting manufacturing tolerances are typically small, a small angle of inclination in this second section is correspondingly also completely sufficient. Accordingly, it is advantageous if, for example, the above-mentioned first angle of inclination assigned to the first section is significantly larger, and is, for example, more than one to two degrees, preferably more than ten degrees, and in particular less than 90 degrees, since since in this way a particularly advantageous weld joint can be provided, which can accommodate a relatively large amount of weld filler material in the molten state. For example, the above-mentioned first angle of inclination can be in the range of approximately 45 degrees.

According to a further advantageous embodiment of the invention, the edge area adjoins a central area of the base body with respect to the first direction, which has a greater wall thickness perpendicularly to the first direction than the edge area. In other words, part of the wall of the base body is removed in the edge area in order to provide the above-described varying cross-sectional geometry in the edge area. In contrast, in other areas of the base body, which are referred to here as central areas of the base body, the base body has a constant wall thickness, which is also greater than in the edge area. It is preferred that the wall thickness in the transition area from the edge area to the central area does not increase linearly, but preferably increases so sharply, quasi-abruptly, that an edge is provided between the edge area and the central area, i.e., an inner edge that faces toward the interior. If the cover is placed on one side of the base body and at the same time is moved towards the base body in the first direction or counter to the first direction, the cover can come into contact on this edge. The cover can, so to speak, be pushed into the interior of the base body at most up to this edge. Due to the above-described tapering inner geometry of the base body, however, the cover will preferably not reach this edge. In case of a failure of the weld seam, for example, such an edge forms an additional protective measure, for example, in order to prevent the cover from penetrating into the interior of the finished cell housing. This makes the cell housing particularly safe. In addition, the above-described bevel in the second section can be implemented particularly easily in this way. The processing of the base body can thus primarily concentrate on the edge area. The rest of the base body can be formed in a simple manner having a constant wall thickness as an extruded component, as already described above. A hole in the base body can additionally be provided in the base body solely for the degassing opening at a different point, that is to say in an area of the base body that is different from the edge area. This opening can easily be cut out.

Accordingly, it represents another very advantageous embodiment if the base body has two opposite sides with respect to the third direction, one of which is defined as a lower side and the other as an upper side, wherein a degassing opening is arranged on the lower side, particularly in the center with respect to the first and second direction. In principle, the lower side can be defined as any side of the base body that is different from its open ends. However, the terms upper side and lower side are preferably related to the intended installation position of the battery cell comprising the base body in a motor vehicle. The base body is thus intended to be used in a motor vehicle in such a way that the lower side of the base body is also directed downwards. In the case of a battery having battery cells arranged on the underbody area of the motor vehicle, which are formed having such cell housings that comprise such a base body, the degassing openings are accordingly directed away from the passenger compartment and downwards, for example in the direction of an underride protection of the motor vehicle. The level of safety may thus be further increased. In case of a thermal event, i.e., a thermal runaway of a battery cell, the releasable degassing opening, which can be closed by a bursting membrane, for example, can open automatically in order to enable controlled degassing of the cell. These very hot gases, which escape from the degassing opening of the cell, can thus advantageously be directed away from a passenger cell and discharged from the cell.

To manufacture the base body, it can first be provided as an extruded profile. A cutout can then be made in the lower side of the base body in order to provide the degassing opening as described. This can be done in particular before the edge areas of the base body are processed in order to provide the above-described varying cross-sectional geometries in the edge area, simultaneously thereto, or also afterwards. A corresponding closure component, also known as a vent element, can be attached to the degassing opening, which provides a bursting membrane. For example, such a bursting membrane can be welded on to cover the degassing opening. The positioning of this degassing opening in the center with respect to the first and second direction has the great advantage that it is then correspondingly at the same distance from the two cell poles arranged on the covers of the cell housing. In this way, the distance to each of the cell poles can be maximized, so to speak. This facilitates the decoupling of the high-voltage path from any gas possibly escaping from the degassing opening.

Furthermore, it is preferred that the lower side and the upper side are smaller in terms of area than the front side and rear side of the base body, which therefore delimit the base body with respect to the second direction. The second direction therefore also represents the preferred stacking direction in which multiple battery cells which have such a cell housing having such a housing component are arranged adjacent to one another in order to provide a battery, in particular a high-voltage battery for a motor vehicle.

In a further advantageous embodiment of the invention, the first housing component represents one of the covers, which has a thickness in the first direction, a width in a second direction perpendicular to the first direction, and a height in a third direction perpendicular to the first and second direction, wherein the edge area delimits the cover in the second and/or third direction and is formed such that an outer diameter of the cover, which defines an outer dimension of the cover in the second and/or the third direction, varies in the first direction, in particular wherein the outer diameter increases at least in areas, starting from a terminal side of the cover on which a pole terminal is arranged, in the direction of an inner side of the cover, which is opposite to the terminal side with respect to the first direction. This is primarily used to provide a weld joint, analogously to what was described for the base body. It is particularly preferred that such a varying cross-sectional geometry for providing such a weld joint is provided both on a respective cover of the cell housing and on the base body. This is precisely what makes it possible to provide a particularly efficient and stable weld seam. In principle, it is also conceivable to use this cross-sectional geometry of the cover to also compensate for tolerances with respect to the base body. However, implementing this via the described second section of the base body is preferred. In particular, this can be formed as described above for the base body, without the need for a correspondingly formed first section of the base body. In other words, the base body can provide the bevel for tolerance compensation in the second section in the edge area, but providing a level for the weld joint is not necessarily required if this is implemented by an appropriate geometric design of the cover itself. Correspondingly, the enlargement of the cover described in the direction of the inside of the cover can also be implemented by an edge that is beveled at least in some areas in the edge area. This can be provided in a particularly simple and cost-effective manner in terms of manufacturing technology.

Both the processing options for the edge area of the cover or the two covers and the processing options for the edge areas of the base body preferably relate to the entire peripheral edge area, which is formed in particular as a closed peripheral area around the above-defined center axis.

Furthermore, the invention also relates to a cell housing for a battery cell, in particular of a motor vehicle, wherein the cell housing has a component according to the invention or one of its embodiments. It is preferred that the cell housing comprises a base body formed as a hollow profile and two covers, which are welded on opposite sides of the base body with respect to a first direction, wherein the housing component represents the base body or one of the two covers, and wherein a respective cover is arranged with respect to the base body in such a way that it protrudes at least partially with respect to the first direction into an interior which is enclosed by the base body.

Otherwise, the cell housing can be designed as already described above. Above all, both the base body and the covers of the cell housing can be designed as described for the housing component according to the invention and its embodiments.

A battery cell having a cell housing according to the invention or one of its embodiments should also be considered as included in the invention. Such a battery cell can be formed, for example, as a lithium-ion cell. Furthermore, the invention also relates to a battery, in particular a high-voltage battery, for a motor vehicle having such a battery cell, preferably having multiple such battery cells. Furthermore, a motor vehicle having such a battery, in particular a high-voltage battery, preferably as a traction battery, should also be regarded as included in the invention.

The motor vehicle according to the invention is preferably designed as an automobile, in particular as a passenger car or truck, or as a passenger bus or motorcycle.

Furthermore, the invention also relates to a method for producing at least part of a prismatic cell housing for a battery cell, which comprises a base body formed as a hollow profile and two covers that are welded or are to be welded on opposite sides of the base body with respect to a first direction. A first housing component is provided for welding to at least one second housing component of the cell housing, wherein the first housing component represents the base body or one of the two covers. Furthermore, the first housing component has an edge area to be arranged on the second housing component, wherein the edge area has a cross-sectional geometry that varies in the first direction with respect to a cross section through the edge area that is parallel to the first direction.

The advantages described for the housing component according to the invention and its configurations and for the cell housing according to the invention and its configurations also apply here in the same way to the method according to the invention.

In addition, in the course of the method according to the invention or its further embodiments, the respective housing components can be manufactured and/or assembled as already described above. According to further embodiments, the method according to the invention can also comprise additional method steps in order, for example, not only to provide part of a prismatic cell housing, but to manufacture the entire cell housing for a battery cell. For example, the base body can initially be provided as an extruded component which is cut to length with respect to the first direction. The processing of the edge areas can then take place later in time. Furthermore, the degassing opening described above can also be cut out. One or more housing covers can also be provided, in particular as blank components having the edge area processed downwards. These edge areas can also be provided with a corresponding geometry. After finished processing of the edge areas of the covers and the base body, the covers can be inserted into the respective edge areas of the base body and welded on. The cell inner workings of the battery cell to be provided can also be introduced into the interior beforehand. The electrolyte can also be poured in later through an opening in the cell housing.

The invention also includes refinements of the method according to the invention, which have features as already described in the context of the refinements of the housing component according to the invention and the cell housing according to the invention. For this reason, the corresponding refinements of the method according to the invention are not described again here.

The invention also comprises combinations of the features of the described embodiments. The invention also comprises implementations that each have a combination of the features of several of the described embodiments, provided that the embodiments were not described as mutually exclusive.

### BRIEF DESCRIPTION OF THE FIGURES

Exemplary embodiments of the invention are described hereinafter. In the figures:

FIG. 1 shows a schematic illustration of a a battery cell having a cell housing in a plan view from below according to an exemplary embodiment of the invention;

FIG. 2 shows a schematic illustration of the base body of the cell housing from FIG. 1 in a schematic plan view from below according to an exemplary embodiment of the invention;

FIG. 3 shows a schematic side view of the battery cell from FIG. 1;

FIG. 4 shows a schematic illustration of the base body of the cell housing from FIG. 1 in a side view;

FIG. 5 shows a schematic illustration of the battery cell from FIG. 1 in a plan view of an end face having a cell terminal according to an exemplary embodiment of the invention;

FIG. 6 shows a schematic illustration of the base body of the cell housing from FIG. 1 in a plan view of an end face; and

FIG. 7 shows a schematic cross-sectional illustration of a cross section through an edge area of the base body and a cover according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also refine the invention independently of one another and are thus also to be considered to be part of the invention individually or in a combination other than that shown. Therefore, the disclosure is also intended to comprise combinations of the features of the embodiments other than those represented. Furthermore, the described embodiments can also be supplemented by further ones of the already described features of the invention.

In the figures, same reference numerals respectively designate elements that have the same function.

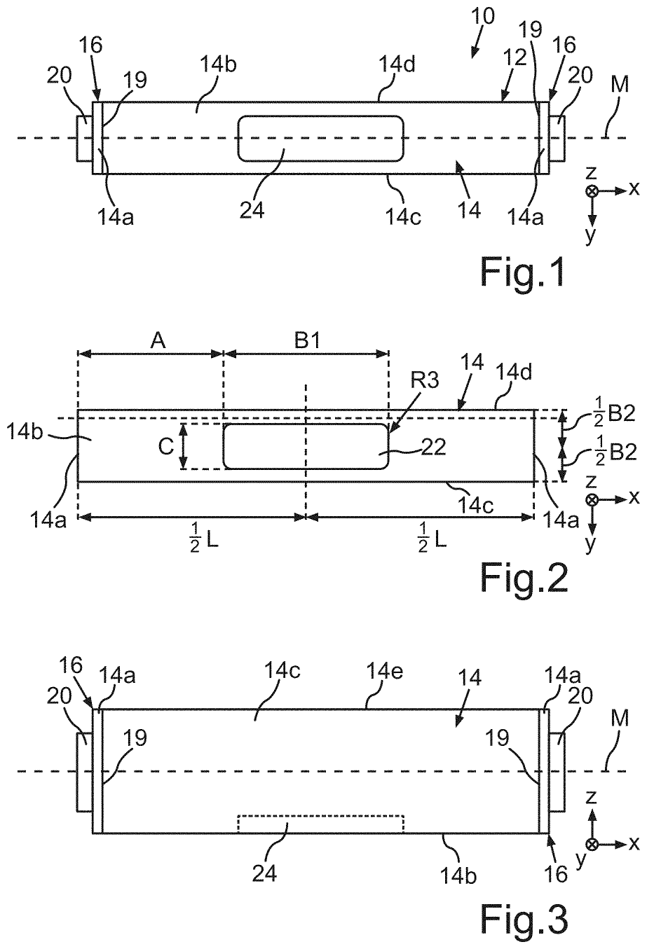

FIG. 1 shows a schematic illustration of a battery cell 10, in particular a prismatic battery cell 10, having a corresponding prismatic cell housing 12 according to an exemplary embodiment of the invention. The battery cell 10 is shown in a plan view from below, in particular with respect to its intended installation position in a motor vehicle. With respect to this intended installation position, the z axis of the coordinate system shown here is accordingly aligned in the direction of a vehicle vertical axis of such a motor vehicle. Such a battery cell 10 is preferably used in a high-voltage battery for such a motor vehicle.

The battery cell 10 can be designed, for example, as a lithium-ion cell. The inner workings of this battery cell 10 are less relevant in the present case and are also not described in more detail hereinafter. The cell housing 12 is designed as a prismatic cell housing 12 and accordingly has a cuboid basic structure. The cell housing 12 is divided into a base body 14 and two covers 16. The base body 14 is manufactured as an extruded hollow profile, preferably made of aluminum.

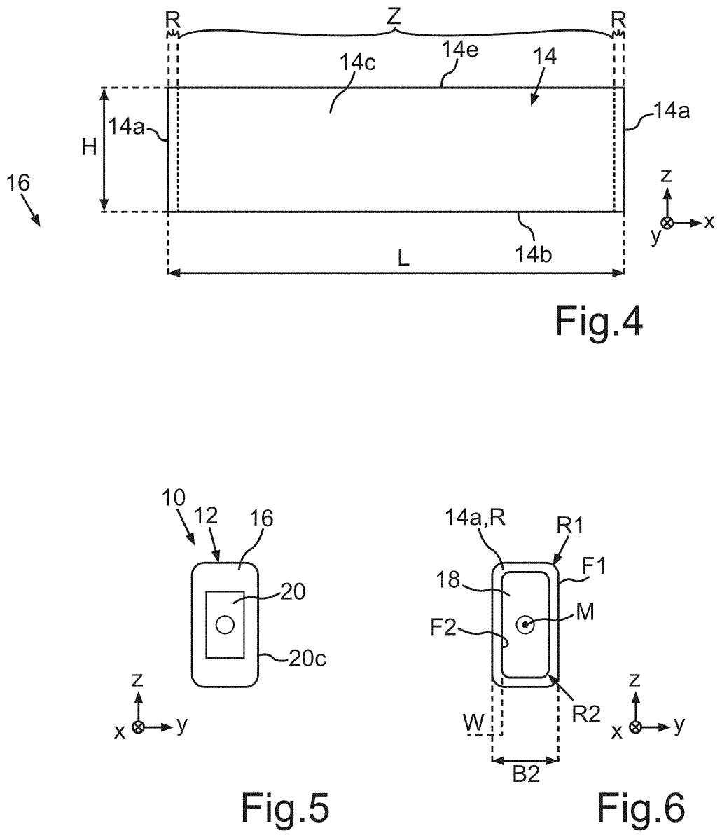

The base body 14 is again shown separately and schematically in FIG. 2 in this bottom view. FIG. 4 correspondingly shows the base body 14 in a side view, and FIG. 6 shows a plan view of an end 14a which delimits the base body 14 in the x direction. Moreover, FIG. 3 shows the battery cell 10 in the side view, in which the base body is illustrated separately in FIG. 4, and FIG. 5 shows the battery cell 10 in the plan view of one of the covers 16. Accordingly, FIG. 1 to FIG. 6 are partially explained jointly hereinafter to describe the battery cell 10 and its cell housing 12.

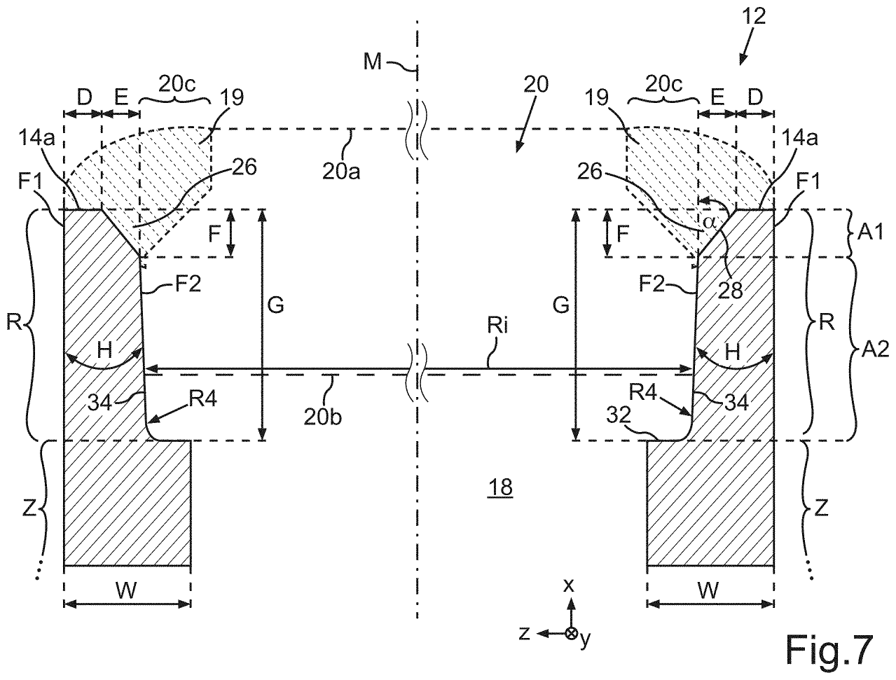

As is apparent in FIG. 6, the base body 14 encloses an interior 18 due to its design as a hollow profile. A cover 16 is arranged on each of the two ends 14a of the base body 14, as shown in FIG. 1. A cell pole or cell terminal 20 is also arranged on a respective cover 16, wherein one of the two cell terminals 20 is assigned to a positive pole and the other of the two terminals 20 to a negative pole of the cell 10. The cell terminals 20 are therefore arranged on opposite sides of the battery cell 10. The covers 16 are welded on the base body 14. The weld seam that connects the cover 16 to the base body 14 is denoted by 19 in FIG. 1 and is illustrated solely schematically. In fact, this weld seam runs in the area of the end face 14a of the base body 14, as shown in FIG. 7, which will be explained in more detail later in conjunction with FIG. 7.

In addition to the two ends 14a, which are also referred to as end faces 14a of the base body 14, among other things, the base body 14 comprises still further sides, namely a lower side 14b, as shown in FIG. 1, a front 14c, a rear side 14d, and an upper side 14e, as can be seen, for example, in FIG. 3 in a side view. On the lower side 14b, the base body 14 has a degassing opening 22 (cf. FIG. 2), which can be closed by a closure element 24, as illustrated in FIG. 1, for example a bursting membrane. This opening 22 is also referred to as a vent opening 22 and, correspondingly, the closure element 24 as a vent element 24.

The battery cell 10 and in particular the base body 14 are designed in such a way that this vent opening 22 points downwards with respect to the intended installation position of the cell 10 in the motor vehicle and is on the lower side of the cell 10. A further special feature of the design of the battery cell 10 is that the cell terminals 20 are arranged on the sides of the cell 10, in particular on opposite sides, as described. Significantly better cooling of the cell 10, for example via the lower side 14b and the upper side 14e, can thus be provided, significantly better decoupling of the high-voltage paths from a gas escaping from the degassing opening 22, and at the same time a particularly compact arrangement of multiple such cells 10 adjacent to one another, in particular in a stacking direction that corresponds to the y direction shown here.

The weld seam 19 is formed completely circumferential here, in particular circumferential with respect to a center axis M, which runs in parallel to the x direction through the center of the base body 14 or a respective cover 16. In particular, this center axis M is arranged centrally with respect to the dimensions of the cover 16 and the base body 14 with respect to the y direction and z direction. This center axis M is shown in FIG. 1, FIG. 3, and FIG. 6, for example. The vent opening 22 and the vent element 24, which are each illustrated in FIG. 2 and FIG. 1, are arranged in the center with respect to the lower side 14b. In other words, the vent opening 22 is located in the center of the lower side 14b of the main housing 14 with respect to the x direction and with respect to the y direction. The center point of this vent opening 22 is equidistant from the two ends 14a of the base body, wherein the distance is designated by ½ L in FIG. 2, since it corresponds to half the length L (see FIG. 4) of the base body in the x direction, and is equidistant from the front and rear sides 14c, 14d, wherein this distance is designated by ½ B2 in FIG. 2, since it corresponds to half the width B2 (see FIG. 6) of the base body in the y direction. As shown in a side view in FIG. 4, the base body 14 has the length L in the x direction and a height H in the z direction. The length L of the base body 14 is greater than the height H. The height H is preferably in turn greater than a width B2 of the base body 14, as shown in FIG. 6. The width B2 correspondingly relates to the dimension of the base body 14 in the y direction.

The dimension of the degassing opening 22 introduced in the base body 14 is characterized by its height C in the y direction and by its width B1 in the x direction. This opening 22 has a substantially rectangular geometry having rounded corners, which are rounded in particular at a radius R3 (see FIG. 2). This designates the radius of curvature of the corners. A rounding of these corners at the radius R3, which is the same for all corners shown, facilitates the manufacturing of the opening 22.

A minimum distance of the opening 22 from the edge 14a is moreover denoted by A. The base body 14 is also rounded in the circumferential direction at a radius of curvature R1, as illustrated in FIG. 6. This relates in particular to the outer surface F1 of the base body 14, while the inner surface F2 facing toward the interior 18 is designed having a radius of curvature R2 in the circumferential direction around the center axis M.

Furthermore, the base body has a wall thickness W, as is also shown in FIG. 6. The base body 14 additionally has an edge area R, which is illustrated in FIG. 4. This edge area R comprises the respective ends 14a of the base body 14 with respect to the x direction and delimits the base body 14 in the x direction. This edge area R defines, so to speak, a section of the base body 14 on both sides of the base body 14 with respect to the x direction, which comprises the edge 14a and extends somewhat in or counter to the x direction towards the center of the base body 14. The wall thickness W just mentioned relates to a wall thickness W of the base body 14 at least in an area of the base body 14 different from this edge area R, namely to a central area Z, as is also schematically shown in FIG. 4. This is because the respective edge areas R of the base body 14 can advantageously have machined surfaces and special geometries for later weld seam placement.

The geometry in the edge area R of the base body 14 and also the corresponding covers 16 will now be explained in more detail with reference to FIG. 7.

FIG. 7 shows a schematic illustration of a cross section perpendicular to the y-axis through an end area of the base body 14 which comprises the edge area R of the base body 14. In this case, the cross-sectional plane runs through the center axis M. The geometry of the base body 14, and of the cover 20, which is only indicated here by dashed lines, in particular both covers 20, is identical in this case to a corresponding cross section perpendicular to the z direction through the center axis M. In other words, the geometry described below in the corresponding edge areas R is formed circumferentially identical with respect to the center axis M, both with respect to the base body 14 and with respect to the covers 20, of which only one is shown here. An outside of the cover 20 facing away from the interior 18 is illustrated by the dashed line 20a, and a side of the cover 20 facing toward the interior 18 by the dashed line 20b. An edge area 20c, which is defined for the cover 20 in the radial direction with respect to the center axis M, can also correspondingly be assigned to the cover 20.

As described, the base body 14 is divided in the x direction into the central area Z and the two edge areas R immediately adjacent to this central area Z in and counter to the x direction. Only one edge area R is described in more detail here, the other of the edge areas R can be formed entirely analogously, however. The wall thickness W of the central area Z is also illustrated in FIG. 7. As can be seen, the edge area R thus has a cross-sectional geometry varying in the x direction. The outer surface F1 (cf. FIG. 6) is formed running in a straight line in the edge area R in the x direction, while the inner surface F2 is processed to form a special geometry and accordingly does not run in a straight line in the x direction. The edge area R is fundamentally designed such that an inner diameter Ri varies in the x direction. In particular, this inner diameter Ri decreases with increasing distance from the ends 14a of the base body. In this way, on the one hand, a particularly advantageous weld joint 26 can be provided, as well as tolerance compensation to compensate for component tolerances between the base body 14 and the cover 20.

The edge area R of the base body 14 can in turn be subdivided into individual partial areas, in particular with respect to the x direction. The edge area R has a first section A1, which also includes the end 14a of the base body 14, and a second section A2 directly adjacent thereto in the x direction. The first section A1 is formed having a beveled edge 28, which is assigned an angle α with respect to the x direction. The weld seam 19 to be introduced between the cover 20 and the base body 14 is also shown. As is apparent, the above-described weld joint 26 can advantageously be provided for this weld seam 19 by this beveled edge 28. As a result, a very reliable welded connection can be provided between the cover 20 and the base body 14. The cover 20 can also be designed accordingly having a corresponding bevel 30 in the edge area 20c of the cover 20. As a result, an even larger volume is provided for the weld seam 19.

In the second section A2, the inner surface F2 of the base body 14 also has an inclination relative to the x direction, which is described by the angle H. This angle is very small and is approximately one to two degrees. Correspondingly, the surfaces F1, F2 in the illustration in FIG. 7 appear almost parallel to one another, but this is not the case in the edge area R. In the central area Z, the surfaces F1, F2 run in parallel to one another, by which the constant wall thickness W in the central area Z is provided. The transition between the second section A2 and the central area Z, which directly adjoins this second section A2 in the x direction or counter to the x direction, is made relatively abrupt. A slight curvature, which can be described by the radius of curvature R4, is present between these two sections A2 and the central area Z. A support edge 32 thus results. The cover 20 can therefore be moved in the direction of the interior 18 at most up to this support edge 32 in or counter to the x direction. Due to the tapering inner diameter Ri, however, the cover 20 preferably already comes into contact with the inner surface F2 of the base body 14 beforehand and is prevented from penetrating further in the interior direction in its position in the x direction or counter to the x direction by the bevel 34 in the second section A2. As a result, tolerance compensation can thus advantageously be provided. Depending on the width of the cover 20, for example in the z direction shown here, it can be introduced more or less deeply into the base body 14 in the direction of the interior 18, but at most up to the support edge 32. Accordingly, it is also advantageous if the cover 20 is formed elevated in a central area, which therefore defines the area of the cover 20 that is different from the edge area 20c, in relation to the edge area 20c in the x direction. This also enables a stable weld seam placement, even if the cover 20 is introduced somewhat deeper into the base body 14 in the direction of the interior 18.

Moreover, G designates the length of the edge area R in the x direction. F designates the height of the first section A1 in the x direction. E designates the dimension of the bevel 28 in the z direction and D the distance of the beveled edge 28 from the outer surface F1. The machined surfaces in the edge area R of the housing or the base body 14 are defined, for example, by the dimensions D, E, F, G and by the angle H and the radius R4. The curves R1, R2, R3, R4, which were explained above, simplify the respective manufacturing steps or processing steps, e.g. to provide the respective components, geometries, cutouts, etc.

Overall, the examples show how the invention provides features on the cell housing having side terminals and vent downward. The lateral terminals in a prismatic cell enable a design in the battery system that was previously only possible using pouch cells. The vent opening downwards theoretically enables a spatial separation of the high-voltage path from the gases that occur in the event of outgassing from the cell. Due to the geometries introduced by machining provided in the edge area of the base body and/or the respective cover, a particularly robust weld seam may be placed and, moreover, tolerance compensation may be provided in a simple and cost-effective manner, which enables a correspondingly simple and cost-effective design of the cell housing.

1. A housing component for a prismatic cell housing of a battery cell, comprising: a base body formed as a hollow profile and two covers that are welded or are to be welded on opposite sides of the base body with respect to a first direction,
wherein the housing component is provided as a first housing component to be welded onto at least one second housing component of the cell housing;
wherein the first housing component represents the base body or one of the two covers;
wherein the first housing component has an edge area to be arranged on the second housing component, wherein the edge area has a cross-sectional geometry that varies in the first direction with respect to a cross section through the edge area that is parallel to the first direction.

2. The housing component of claim 1, wherein the first housing component represents the base body formed as a hollow profile, which has a length in the first direction, a width in a second direction perpendicular to the first direction, and a height in a third direction perpendicular to the first and second direction, wherein the base body encloses an interior, wherein the edge area comprises an edge delimiting the base body in the first direction and providing an end face of the base body, wherein the edge area is formed such that an inner diameter of the base body, which defines an inner dimension of the base body in the second and/or the third direction, decreases in the edge area with increasing distance from the edge.

3. The housing component of claim 1, wherein the edge area has a first section with respect to the first direction, wherein the first section comprises the edge, wherein the first section has a beveled edge facing toward the interior, in particular an edge beveled according to a first angle of inclination with respect to the first direction.

4. The housing component of claim 1, wherein the edge area has a second section with respect to the first direction, which adjoins the first section, wherein the second section comprises an inner side facing toward the interior, which is inclined with respect to the first direction, in particular by a second angle of inclination that is less than the first angle of inclination and that is in the single-digit degree range.

5. The housing component of claim 1, wherein the edge area adjoins a central area of the base body with respect to the first direction, which has a greater wall thickness perpendicular to the first direction than the edge area.

6. The housing component of claim 1, wherein the base body has two opposite sides with respect to the third direction, one of which is defined as a lower side and the other as an upper side, wherein a degassing opening is arranged in the lower side, in particular in the center with respect to the first and second direction.

7. The housing component of claim 1, wherein the first housing component represents one of the covers, which has a thickness in the first direction, a width in a second direction perpendicular to the first direction, and a height in a third direction perpendicular to the first and second direction, wherein the edge area delimits the cover in the second and/or third direction and is formed such that an outer diameter of the cover, which defines an outer dimension of the cover in the second and/or the third direction, varies in the first direction, in particular wherein the outer diameter increases at least in areas, starting from a terminal side of the cover on which a pole terminal is arranged, in the direction of an inner side of the cover, which is opposite to the terminal side with respect to the first direction.

8. A cell housing for a battery cell, which has the housing component of claim 1, wherein the cell housing comprises a base body formed as a hollow profile and two covers, which are welded on opposite sides of the base body with respect to a first direction, wherein the housing component represents the base body or one of the two covers, wherein a respective cover is arranged with respect to the base body in such a way that it protrudes at least partially with respect to the first direction into an interior which is enclosed by the base body.

9. A method for producing at least part of a prismatic cell housing for a battery cell, which comprises a base body formed as a hollow profile and two covers, which are welded or are to be welded to opposite sides of the base body with respect to a first direction, the method comprising the following steps:
providing a first housing component to be welded on at least one second housing component of the cell housing;
wherein the first housing component represents the base body or one of the two covers;
wherein the first housing component has an edge area to be arranged on the second housing component, wherein the edge area is processed in such a way that it has a cross-sectional geometry that varies in the first direction with respect to a cross section through the edge area that is parallel to the first direction.

10. The method of claim 9, wherein the base body is provided by means of an extrusion method.

11. The housing component of claim 2, wherein the edge area has a first section with respect to the first direction, wherein the first section comprises the edge, wherein the first section has a beveled edge facing toward the interior, in particular an edge beveled according to a first angle of inclination with respect to the first direction.

12. The housing component of claim 2, wherein the edge area has a second section with respect to the first direction, which adjoins the first section, wherein the second section comprises an inner side facing toward the interior, which is inclined with respect to the first direction, in particular by a second angle of inclination that is less than the first angle of inclination and that is in the single-digit degree range.

13. The housing component of claim 3, wherein the edge area has a second section with respect to the first direction, which adjoins the first section, wherein the second section comprises an inner side facing toward the interior, which is inclined with respect to the first direction, in particular by a second angle of inclination that is less than the first angle of inclination and that is in the single-digit degree range.

14. The housing component of claim 2, wherein the edge area adjoins a central area of the base body with respect to the first direction, which has a greater wall thickness perpendicular to the first direction than the edge area.

15. The housing component of claim 3, wherein the edge area adjoins a central area of the base body with respect to the first direction, which has a greater wall thickness perpendicular to the first direction than the edge area.

16. The housing component of claim 4, wherein the edge area adjoins a central area of the base body with respect to the first direction, which has a greater wall thickness perpendicular to the first direction than the edge area.

17. The housing component of claim 2, wherein the base body has two opposite sides with respect to the third direction, one of which is defined as a lower side and the other as an upper side, wherein a degassing opening is arranged in the lower side, in particular in the center with respect to the first and second direction.

18. The housing component of claim 3, wherein the base body has two opposite sides with respect to the third direction, one of which is defined as a lower side and the other as an upper side, wherein a degassing opening is arranged in the lower side, in particular in the center with respect to the first and second direction.

19. The housing component of claim 4, wherein the base body has two opposite sides with respect to the third direction, one of which is defined as a lower side and the other as an upper side, wherein a degassing opening is arranged in the lower side, in particular in the center with respect to the first and second direction.

20. The housing component of claim 5, wherein the base body has two opposite sides with respect to the third direction, one of which is defined as a lower side and the other as an upper side, wherein a degassing opening is arranged in the lower side, in particular in the center with respect to the first and second direction.
